(19) United States
(12) Patent Application Publication
(10) Pub. No.: US 2007/0179415 A1
(43) Pub. Date: Aug. 2, 2007

(54) Child car seat

(76) Inventor: Fonda Evans, (US)

Correspondence Address: MICHAEL BERNS;MALONEY, PARKINSON AND BERNS, 135 W MAIN STREET, URBANA, IL, 61801, US

(21) Appl. No.: 11/341,760

(22) Filed: Jan. 27, 2006

(51) Int. Cl. A61H 15/00

(52) U.S. Cl. 601/126; 601/128; 601/122; 601/115

(57) ABSTRACT

A child car seat that provides a massaging vibration for soothing the child. A massage or vibration may be used to provide comforting to a fussy infant. A remote control may also be used to control the operation by the driver or other occupant with ease.

### BACKGROUND OF THE INVENTION

The present invention relates to child and infant car seats. Typically, children under 3 years of age and 40 pounds must be restrained in a car seat. Recent laws require cars seats to 8 years of age. During car rides, children can become upset or fussy with little opportunity for the driver to do anything to help the child.

### DESCRIPTION OF THE PRIOR ART

Car seats have not used modern electronics to provide benefits to the parents and use of the seat. U.S. Pat. D371,248 discloses a musical rocking infant car seat. U.S. Pat. No. 4,634,177 discloses an Interlocking Infant Carrier and Base for Car Seat Mounting. U.S. Pat. No. 5,884,967 discloses a Child Safety Seat.

Child car seats of the past have failed to provide additional benefits that would produce a superior seat. Additional features would make the product more marketable, and make the parents feel safer. If the child is more comfortable, the parents will be less distracted in driving, and need to attend to the child less.

### SUMMARY OF THE INVENTION

The present invention provides a number of features, separately, or in combination, to enhance the performance of the child seat. A massaging device included within the seat soothes the child during driving. The invention provides a soothing massage and vibration to relax and comfort the child. Music can also be provided to soothe the baby.

### DESCRIPTION OF THE DRAWINGS

FIG. 1 is a perspective view of an embodiment of the roller system of the invention, without the infant car seat.

FIG. 2 is a front view of an embodiment of the roller system of the invention.

FIG. 3 is a top view of an embodiment of the roller system of the invention.

FIG. 4 is a side view of an embodiment of the roller system of the invention.

FIG. 5 is a detail view of the motor drive system of an embodiment of the invention.

FIG. 6 is a wiring diagram of an embodiment of the invention.

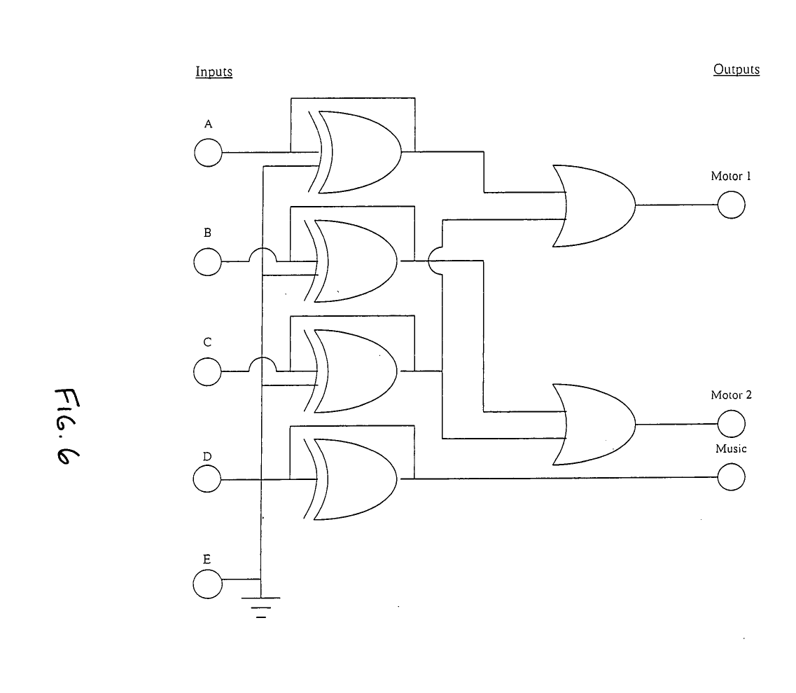

FIG. 7 is a front view of a remote control device.

### DETAILED DESCRIPTION OF THE PREFERRED EMBODIMENT

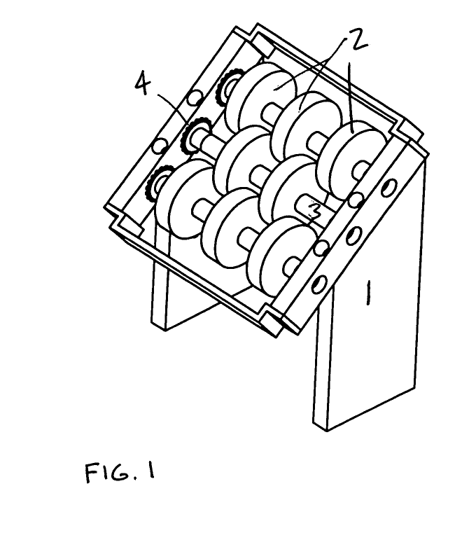

A massage device 1, as shown in FIG. 1 is provided in a child's car seat to comfort and relax the child. Music is may be provided to soothe and entertain the child.

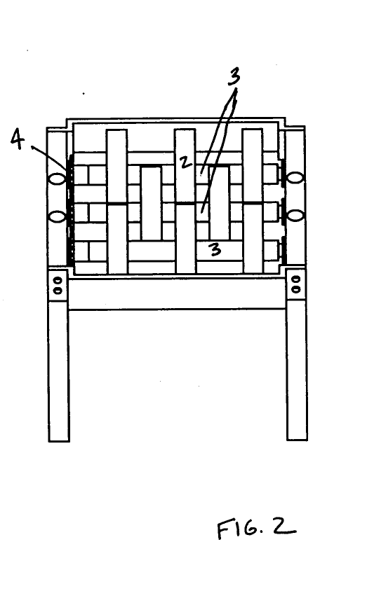

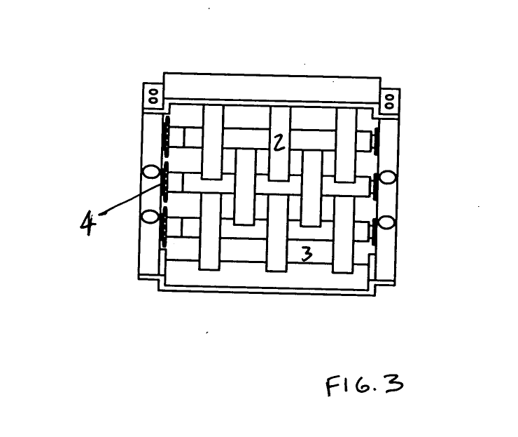

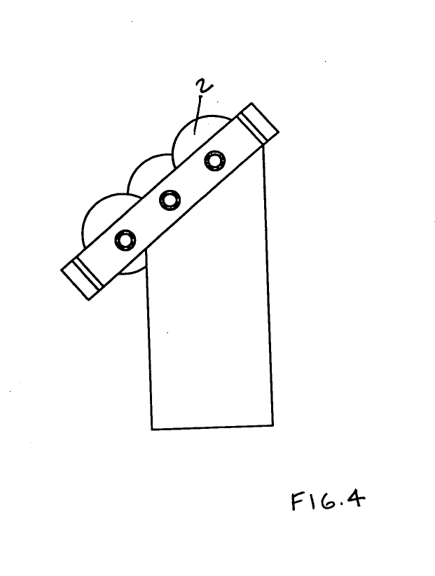

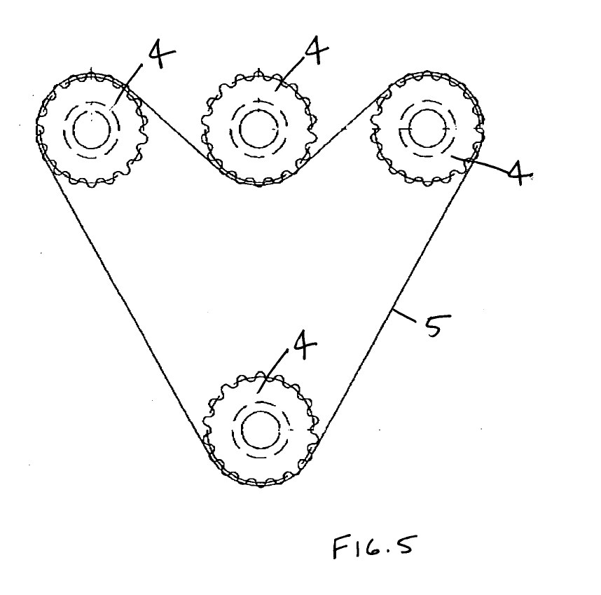

The preferred embodiment shown in the drawings was designed to fit into a Graco Snugride Model 8643DOH infant car seat. Other models of car seats and infant car seats would be suitable to utilize the invention. The embodiment shown in FIG. 1 through FIG. 5 was designed to be added to the infant car seat. It is possible to sell the product as an after-market kit to add to a car seat, but in another embodiment, the invention would be incorporated into the car seat design. The embodiment shown in the drawings was designed to be attached to a car seat base

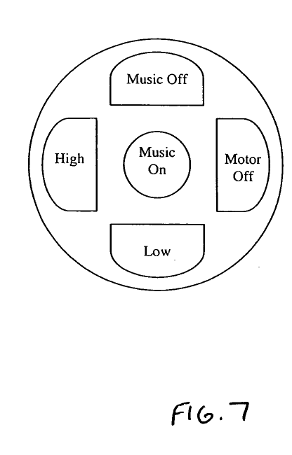

A remote control may also be provided to operate the features of the seat, as shown in FIG. 7. It may include the massager, the speakers, and other features. The remote control may also allow for a keychain connection.

The seat would also have the standard safety features of a car seat. This may also include an adjustable strap for locking the seat in place.

The preferred embodiment utilized a 12 volt connection to attach the invention to the outlet provided in vehicles, often used as the car cigarette lighter. An AC adapter to transform 120 volt or other service to 12 volts direct current could be used for home power connection. Alternative embodiments may utilize batteries or rechargeable battery packs.

The massaging cam rollers 2 are attached to axles 3 that are driven by drive gears 4. A belt chain 5 may transfer the rotation from a motor to rotate the drive gears 4 and the axles 3. The massaging cam rollers 2 are rotated and press toward the child in the car seat to provide a massaging motion.

Each axle 3 is preferably placed between two brass bearings to provide a smooth rotation. The motor as shown in the figures is located approximately 2 inches below the axles 3.

Typically, an installation would include a decorative, washable outer layer, which the child would sit on. Below that may be a thin padding, preferably a Teflon sheet, to provide cushioning, comfort, and safety. The massaging units 1 would lie beneath the outer layer, sufficiently to allow some cushioning of the massage, but not prevent the child from feeling the massaging units 1.

As the massaging rollers 2 create a massaging motion, they may wear on the cushioning or outer layer. A reinforced area may be necessary to prevent the massaging units 1 from damaging the cushioning or outer layer material.

The massaging rollers 2 are preferably designed to alter the rolling motion to provide a massaging benefit. This may be accomplished by using non-circular cams to provide different distances from the axles 3 to push toward the child user sitting in the car seat. This was also accomplished by using circular cam massaging rollers 2 attached to the axles 3 offset from the center of the massaging rollers 2. A successful embodiment used a cam roller 2 having a diameter of 1.50 inches and a width of 0.375 inches. The offset distance of the axle 3 from the center of the cam roller 2 was set at 0.173 inches. This resulted in an oscillation amplitude of 0.346 inches and was found to be appropriate for massaging a child in the car seat.

A possible remote control unit is shown in FIG. 7. As shown in the drawing, controls may be provided for providing music in the car seat. Music sources including compact disc, MP3 players, radios, pre-recorded tracks, DVD, etc. may be provided in the car seat for the infant.

The massaging unit 1 may be isolated from the car seat base by the use of an electrical isolation pad. A successful pad was built by using a 0.0313 inch pad of PolyTetraFluoroEthylene (PTFE).

1. A child car seat comprising:
a car seat,
a plurality of axles attached to the car seat,
a plurality of rollers attached to the plurality of axles,
means for rotating the rollers, such that the rollers provide a massaging action to the car seat user.

2. The child car seat according to claim 1, wherein the means for rotating the rollers is a motor attached to a car 12 volt power outlet connection.

3. A kit for adding a massaging feature to a car seat comprising:
a plurality of axles attached to a frame,
a plurality of rollers attached to the plurality of axles,
means for rotating the rollers, such that the rollers provide a massaging action to the car seat user.
